(19) United States
(12) Patent Application Publication
(10) Pub. No.: US 2021/0347606 A1
(43) Pub. Date: Nov. 11, 2021

(54) IMPROVEMENTS IN OR RELATING TO STAIRLIFTS

(71) Applicant: Stannah Stairlifts Limited, Hampshire (GB)

(72) Inventors: Alexander Henry Gage Wilson, Hampshire (GB); Jacob George Harry Lockhart Paisley, Malvern Worcestershire (GB); Alan Neil Russell Stannah, Andover Hampshire (GB)

(21) Appl. No.: 17/274,224

(22) PCT Filed: Aug. 27, 2019
(86) PCT No.: PCT/GB2019/052390

§ 371 Date: Mar. 8, 2021

(30) Foreign Application Priority Data
Sep. 7, 2018 (GB) 1814618.3

(51) Int. Cl. B66B 5/00; B66B 9/08; B66B 1/34

(52) U.S. Cl. CPC B66B 5/0031; B66B 1/3453; B66B 9/0807

(57) ABSTRACT

A stairlift has a communication interface configured to allow communication between a user and a remote site via a variety of communication technologies whilst preventing use of the stairlift if a user is not accompanied by a means of communicating.

### CROSS-REFERENCE TO RELATED APPLICATIONS

This application is the U.S. national stage of PCT/GB2019/052390 filed Aug. 27, 2019, which claims priority of United Kingdom patent application 1814618.3 filed Sep. 7, 2018, both of which are hereby incorporated by reference in their entirety.

### FIELD OF THE INVENTION

This invention relates to stairlifts and, in particular, to a stairlift configured to facilitate 2-way communication to and from a stairlift user.

### BACKGROUND TO THE INVENTION

A stairlift is a safety-critical device widely installed in private homes to enhance the mobility of persons having at least a degree of physical disability and no particular technical training.

From time to time faults arise in the stairlift and these faults can be communicated without user intervention to a remote site. An example of this is described in European Patent 1 938 048. However, if a fault arises or a user otherwise becomes alarmed in the course of a journey, the user may need to seek outside assistance to establish what action is safe and/or appropriate in the circumstances.

The fault finding and communication system described in European Patent No. 1 938 048 is a bespoke system built into the stairlift, the stairlift including a built-in communications facility whereby a user can communicate with a remote location. A similar bespoke system for communicating stairlift faults is described in UK Patent Application No. GB 2 550 323 while European Patent Application No. 3 406 555 includes a built-in telecommunications facility to allow communications between a stairlift user and a remote site. In all of these cases, the addition of a communications facility adds cost and complication to the stairlift carriage and, in the case of EP 3 406 555, a separate account may be required for the built-in telecoms facility.

### SUMMARY OF THE INVENTION

It is an object of the invention to provide a stairlift which will go at least some way in addressing the problems or drawbacks associated with the aforementioned apparatus; or which will at least provide a novel and useful choice.

Accordingly, in one aspect, the invention provides a stairlift having a rail; a carriage mounted on said rail; a drive facility configured and operable to drive said carriage along said rail; and a control facility configured and operable to control the operation of said drive facility wherein said stairlift further includes a communications interface configured to communicate with an external communications facility and wherein said control means is operable to determine if said communications interface is operatively connected to an external communications facility and, in the absence of a connection, to disable said drive facility.

Preferably said communications interface is configured to communicate with a telecommunications device.

Preferably said communications interface is configured to communicate with a mobile telephone.

Preferably said communications interface is configured for wireless communication with said communications device.

Preferably said communications interface is configured for communication via a Bluetooth link.

Preferably said stairlift includes a chair and a sensor operative to sense the presence of a stairlift user seated in said chair, and wherein said control facility is configured to prevent Bluetooth communication between said stairlift and said communications device in the absence of a stairlift user being seated in said chair.

In an alternative the communications interface is configured for wired communication with said communications device and wherein said control facility is configured to prevent operation of said stairlift in the absence of a wired connection between said communications device and said communications interface.

Preferably said control facility is configured to respond to an application programme present on said communications device, said application programme being configured to enable control over stairlift functions including landing controls, directional controls, chair swivelling, chair folding, footrest folding and/or hinge operation.

Preferably said communications interface is configured to receive communications from a remote location via said communications device.

Said communications interface may incorporate or be configured to communicate with a virtual assistant.

Preferably said virtual assistant is configured to receive commands from a remote location.

Said virtual assistant may be selected from a group comprising Alexa, Siri, Google Assistant, Bixby and Cortana.

In a second aspect the invention provides a user security system for a location including: a stairlift as disclosed herein; and a door entry mechanism responsive to an electronic command, said system including an operating facility configured to issue an electronic command to operate said door entry mechanism following a communication from the stairlift of a fault or call for assistance.

Many variations in the way the present invention can be performed will present themselves to those skilled in the art. The description which follows is intended as an illustration only of one means of performing the invention and the lack of description of variants or equivalents should not be regarded as limiting. Within the scope of the invention as defined by the appended claims, wherever possible, a description of any element should be deemed to include any and all equivalents thereof whether in existence now or in the future.

### BRIEF DESCRIPTION OF THE DRAWINGS

The various aspects of the invention will now be described with reference to the example shown in the accompanying drawings in which:

FIG. 1 is a drawing showing a typical stairlift to which the invention may be applied; and

FIGS. 2 to 4 are schematic drawings showing examples of systems having stairlifts incorporating the invention.

### DETAILED DESCRIPTION OF WORKING EMBODIMENTS

In broad terms the invention describes systems for stairlifts that are designed to ensure that a stairlift user, when using the stairlift, has the ability to access assistance, particularly in the event a fault arises in the stairlift in the course of a journey. As will become apparent from the following description, the systems require little technical adaptation of a stairlift and makes use of widely available communications devices.

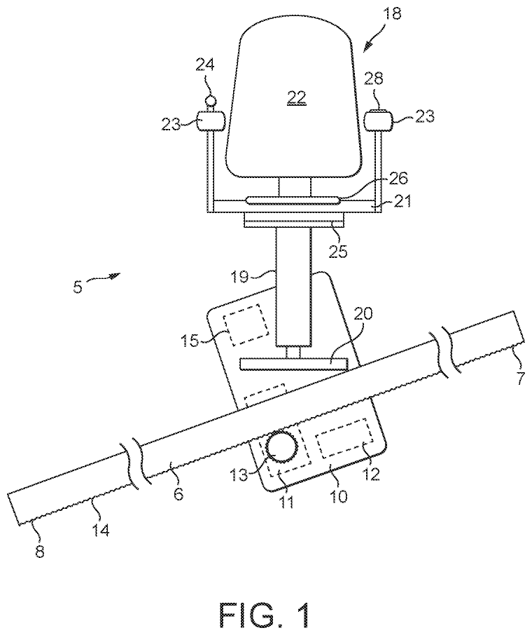

Referring firstly to FIG. 1, a typical stairlift 5 is shown comprising a rail 6 having an upper end 7 and a lower end 8. A carriage 10 is mounted on the rail for movement along the rail between ends 7 and 8 and vice versa. To this end the carriage includes a drive motor/gearbox unit 11 powered from one or more batteries 12. In this example, a drive pinion 13 is provided on the output of the motor/gearbox unit 11, the pinion engaging a rack 14 extending along the underside of the rail 6 but other forms of drive could be used without departing from the scope of the invention. A control unit or ECU 15 is connected to the motor 11 to control the operation of the motor and various other functional components of the stairlift.

In the conventional manner a chair 18 is mounted on the carriage 10 via a chair interface 19, the interface 19 also serving as a mount for a footrest 20. In the example shown the chair comprises a seat base 21, backrest 22 and armrests 23. Although not illustrated, those skilled in the art will appreciate that the footrest 20, seat base 21, and armrests 23 can be folded between the operating positions shown in FIG. 1, and folded positions in which they are aligned substantially vertically to reduce the intrusion of the stairlift into the staircase when not in use.

A user control 24 is mounted on one armrest 23 whereby a user can cause the carriage to move along the rail. The chair may further incorporate a swivel mechanism 25 and, for reasons that will become apparent later in this description, the chair preferably further includes an occupancy sensor 26 incorporated in the seat base 21 to provide an indication of whether or not the chair is occupied by a user.

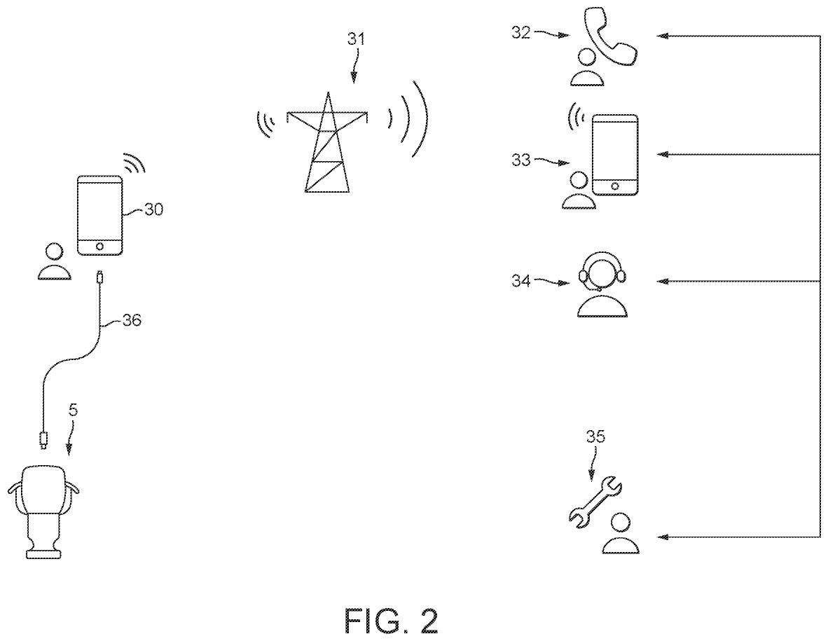

Referring to FIG. 2, a schematic system is shown comprising a stairlift 5, a communications device 30, a transmitter 31, remote telecommunications receivers 32 and 33, a service centre 34, and a service engineer 35. The communications device 30 is conveniently a telecommunications device and, more conveniently, a ‘smart’ mobile telephone such as, for example, an iPhone sold by Apple Corporation although smart fixed and mobile telephones offered by other manufacturers may be used with equal applicability.

The stairlift 5 is provided with a communications interface that, in this example, allows the stairlift to be connected to the telecommunications device 30 by a cable 36. To this end the interface may comprise or include a USB socket 28 positioned on one of the armrests 23 or in any other position, readily accessible to a user. The socket 28 is operatively connected to the ECU 15 or to another form of electronic intelligence within the stairlift that has a degree of control over the operation of the stairlift. The ECU or other control intelligence is configured to respond to connections made to the socket 28.

The arrangement of this system is such that the ECU 15 is configured to prevent operation of the stairlift 5 unless the communications device 30 is operatively connected to the socket 28 by cable 36. This ensures that a user always has a means of communicating with a remote source of assistance should assistance be required in the course of a journey or intended journey. The device 30 in the form of a smart phone may be provided with a pre-programmed application (‘App’), the App preferably launching automatically when the device 30 is connected to the stairlift 5 to allow at least some of the functionality of the stairlift to be controlled from the device 30. The App may also be configured to communicate with fault sensing functionality included within the ECU 15 and to automatically relay fault information pertaining to the stairlift, via transmitter 31, to receivers 32 and 33 and to service centre 34 so that service engineer 35 can be alerted and, if necessary, make a service call. If appropriate, corrective data and/or messages can be transmitted back to the stairlift and user via the App.

The App may include pre-programmed contact numbers selectable by a user to allow a user to communicate with identified telecommunications receivers 32 and 33 such as, for example, receivers of a neighbour, family member and/or identified care-giver. The App may also be configured to allow functions such as landing controls, directional controls, chair swivelling, chair folding, footrest folding and/or operation of a hinge in the rail to be effected from the device 30.

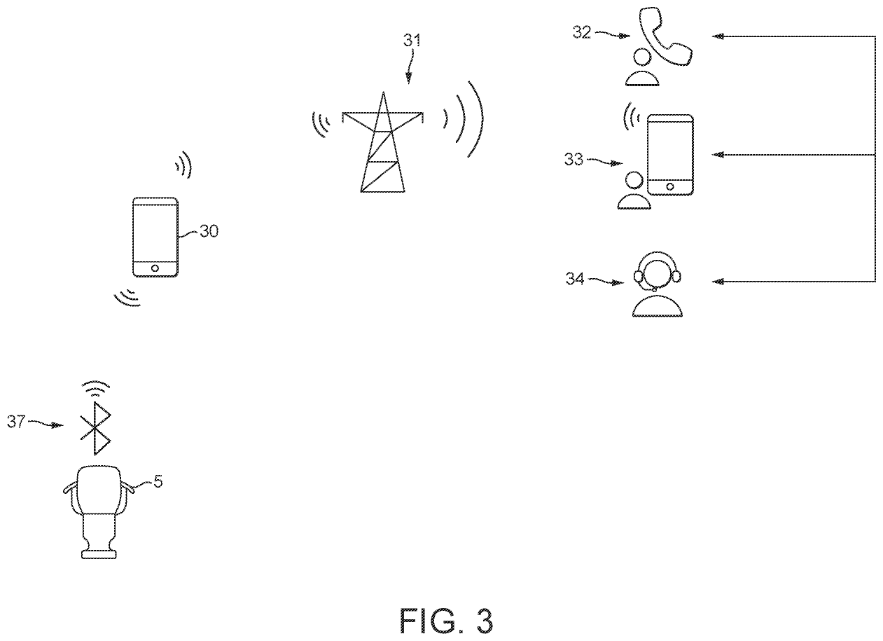

A similar system is shown in FIG. 3 except that in place of, or in addition to, cable 36 of the previous example, wireless communication functionality 37 is used to establish a working link between the device 30 and the stairlift. Suitable functionality may include Bluetooth typically built into smart phones such as, for example, iPhones sold by Apple Corporation. In this example the communications interface on the stairlift 5 comprises or includes a Bluetooth pairing facility and the stairlift ECU 15 is configured to allow the stairlift to be operated only when the device 11 is paired to the stairlift. To ensure correct and safe use of the stairlift in this example, occupancy sensor 26 is linked to the ECU 15, and the ECU configured to prevent pairing of the device 30 to the stairlift when the chair 18 is not occupied by a user.

This example may otherwise include all the features and functionality of the example shown in FIG. 2.

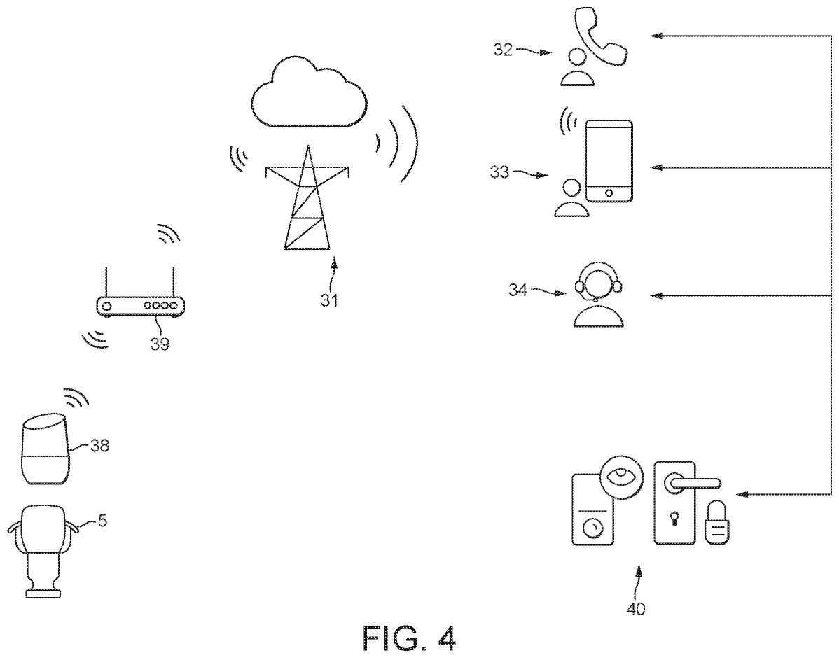

Referring to FIG. 4, a further variation on the systems above described is shown in which, in place of a telecommunications device, the communications interface incorporates or is configured to communicate with a virtual assistant 38, operative parts of which may be mounted on or integrated into the stairlift, or which can be connected by cable or pairing to the stairlift to communicate with a remote site via internet connection 39. This enables a stairlift user to undertake 2-way communication by voice alone and, as with previous examples, the virtual assistant may be configured to operate in conjunction with a chair occupancy sensor 26. Again further functionality may be built into the stairlift to enable faults to be communicated to a remote site via the virtual assistant which is preferably selected from a group comprising Alexa, Siri, Google Assistant, Bixby and Cortana or any development or replacement thereof or addition thereto.

As with the examples described above, communications from a stairlift user may be sent to multiple recipients and the recipients automatically distinguished so that one recipient is selected or identified to take responsibility for responding; and messages returned to the user indicating that the concerns have been received and, if necessary, that help is on its way.

The Example in FIG. 4 illustrates the use of a user security system for a location in which a stairlift is installed, a system which could also be used in any of the previous examples. As shown the user security system includes a smart door entry device 40 to allow a care provider or service technician to gain access to the user's home in the event a communication from the stairlift indicates that a personal attendance is required. In this example the smart door entry device operates in response to an electronic command which may be triggered by or from an operating facility including one or more of the telecommunications receivers 33, 33 or 34. In this way, upon notice of a fault and/or a call for assistance being received from the stairlift, the door entry device 40 can be operated remotely to allow a care provider or service technician access to the property to provide assistance. The App described above could also be configured to allow a user to operate the door entry device 40, particularly if stranded on the stairlift mid-journey and in need of assistance to safely vacate the stairlift.

1. A stairlift comprising:
a rail;
a carriage mounted on said rail;
a drive facility configured and operable to drive said carriage along said rail; a control facility configured and operable to control the operation of said drive facility; and
a communications interface configured to communicate with an external communications facility;
wherein said control means is operable to determine if said communications interface is operatively connected to an external communications facility and, in the absence of a connection, to disable said drive facility.

2. The stairlift as claimed in claim 1, wherein said communications interface is configured to communicate with a telecommunications device.

3. The stairlift as claimed in claim 2, wherein said communications interface is configured to communicate with a mobile telephone.

4. The stairlift as claimed in claim 1, wherein said communications interface is configured for wireless communication with said communications facility.

5. The stairlift as claimed in claim 1, wherein said communications interface is configured for communication via a Bluetooth link.

6. The stairlift as claimed in claim 5, wherein said stairlift includes a chair and a sensor operative to sense the presence of a stairlift user seated in said chair, and wherein said control facility is configured to prevent Bluetooth communication between said stairlift and said communications facility in the absence of a stairlift user being seated in said chair.

7. The stairlift as claimed in claim 1, wherein said communications interface is configured for wired communication with said communications facility and wherein said control facility is configured to prevent operation of said stairlift in the absence of a wired connection between said communications facility and said communications interface.

8. The stairlift as claimed in claim 1, wherein said control facility is configured to respond to an application programme present on said communications facility, said application programme being configured to enable control over stairlift functions including landing controls, directional controls, chair swivelling, chair folding, footrest folding and/or hinge operation.

9. The stairlift as claimed in claim 1, wherein said communications interface is configured to receive communications from a remote location via said communications facility.

10. The stairlift as claimed in claim 1, wherein said communications interface incorporates or is configured to communicate with a virtual assistant.

11. The stairlift as claimed in claim 10, wherein said virtual assistant is configured to receive commands from a remote location.

12. The stairlift as claimed in claim 10, wherein said virtual assistant is selected from a group comprising Alexa, Siri, Google Assistant, Bixby and Cortana.

13. A user security system for a location, comprising:
a stairlift as claimed in claim 1;
a door entry mechanism responsive to an electronic command; and
an operating facility configured to issue an electronic command to operate said door entry mechanism following a communication from the stairlift of a fault or call for assistance.
